(19) United States
(12) Patent Application Publication
(10) Pub. No.: US 2018/0160819 A1
(43) Pub. Date: Jun. 14, 2018

(54) Sleep pod with controlled environment

(71) Applicant: Helene F. RUTLEDGE, New York, NY (US)

(72) Inventor: Helene F. RUTLEDGE, New York, NY (US)

(21) Appl. No.: 15/530,192

(22) Filed: Dec. 12, 2016

(51) Int. Cl. A47C 21/04; A47C 31/00; E05F 15/60; E05F 15/53; E05F 1/04; A47C 21/00; A47C 21/08

(52) U.S. Cl. CPC A47C 21/04; A47C 31/008; E05F 15/60; E05F 15/53; E05Y 2900/20; A47C 21/006; A47C 21/003; A47C 21/08; E05F 1/04

(57) ABSTRACT

An environmentally controlled sleep pod comprises: a) a main frame having an elevated base for supporting a mattress, a mechanical system storage area, and having walls extending upwardly, with a mattress sidewall portion and rail portion; b) a mattress on the base; c) a mechanical system located in its storage area, with heating and air-conditioning and power source connector; d) feed conduit(s) connected to the mechanical system and extending up the main frame walls to the rail portion for feeding air to above the mattress; e) return conduit(s) connected to the above-mattress rail portion of the main frame walls extending down the main frame walls to the mechanical systems for returning air from above the mattress; f) a control device for heating and cooling of air at the mechanical system; and g) a moveable hood connected to the main frame and having an open position and a closed position.

### REFERENCE TO RELATED APPLICATIONS

The present application is not related to any pending or issued United States of America or foreign patent or patent application.

### BACKGROUND OF INVENTION

### a. Field of Invention

The present invention generally relates to unique sleeping pods, for individuals, couples or otherwise, adults, children and infants wherein the air is circulated in a closed or semi-closed pod with environmental controls as well as many other comfort features, such as internet, television, movies, music, massage, cell phone, biomedical monitoring, including data collection for personal use and data transmittal to a doctor, clinic or other medical facility. The present invention sleep pods include heating, air conditioning, humidity controls, air flow controls and even optional oxygen supply.

### b. Description of Related Art

The following patents are representative of the field pertaining to the present invention:

U.S. Pat. No. 9,131,781 B2 to Zaiss et al describes a system that includes an air distribution pad and an air distributor. The air distribution pad is adapted to fit substantially on an upper bed surface of a mattress of an adjustable bed and comprises a head portion, a foot portion, a longitudinal middle portion between the head portion and the foot portion, and an upper surface extending along the head portion, the longitudinal middle portion and the foot portion. The air distributor is operably connected to the air distribution pad so as to create a flow path from the air distributor through the air distribution pad to the upper surface. The air distributor is connected to the air distribution pad within the longitudinal middle portion of the air distribution pad.

U.S. Pat. No. 8,727,978 B2 to Tran et al describes a heart monitoring system for a person that includes one or more wireless nodes; and a wearable appliance in communication with the one or more wireless nodes, the appliance monitoring vital signs.

U.S. Pat. No. 8,402,579 B2 to Marquette et al describes a climate controlled seat, bed or other assembly configured to receive a person includes a blower and two or more thermoelectric devices or other conditioning fluid modules. According to one embodiment of an operational scheme, a control system for the seat or bed is configured to continuously discharge air from the blower through the thermoelectric devices. In one arrangement, the thermoelectric devices are sequenced between an activated and a deactivated position. Consequently, the desired cooling and/or cooling effect can be maintained while reducing energy consumption of the climate control system.

U.S. Pat. No. 8,181,290 B2 to Brykalski et al describes that according to certain arrangements, a climate controlled bed includes an upper portion comprising a core with a top core surface and a bottom core surface. The core includes at least one passageway extending from the top core surface to the bottom core surface. The upper portion of the bed further includes at least one fluid distribution member positioned above the core, wherein the fluid distribution member is in fluid communication with at least one passageway of the core. The fluid distribution member is configured to at least partially distribute fluid within said fluid distribution member. The upper portion of the bed further comprises at least one comfort layer positioned adjacent to the fluid distribution member. The bed also includes a lower portion configured to support the upper portion and at least one fluid module configured to selectively transfer air to or from the fluid distribution member of the upper portion. In some arrangements, the fluid module includes a fluid transfer device and a thermoelectric device for selectively thermally conditioning fluids being transferred by the fluid transfer device.

U.S. Pat. No. 8,157,849 B1 to Gilbride describes that a tanning bed air filter is provided that filters incoming air that is provided to tanning beds. An air filter, complete with holder, filter media, and cover screen is provided on the outside of the bed. The filter provides for the filtering of incoming air to the bed, which may be sucked in by internal fans, or by natural convection due to the heating property of the bed. The cover of the invention allows for easy removal, thus exposing the filter media, which may be cleaned or replaced.

U.S. Pat. No. 8,025,056 B2 to Lewis describes a portable hyperbaric chamber system that includes a soft-sided, foldable hyperbaric chamber and a substantially rigid, removable, external support structure. The chamber generally includes a wall of a substantially non-breathable, soft-sided, and foldable material and an accessway sealable with a non-breathable closure so as to maintain a hyperbaric pressure within the chamber. The chamber also includes at least one fastener, such as a bolt or threaded stud, extending from the wall that permits the chamber to be removably attached to the support structure, thereby to maintain the chamber in an uncollapsed state when the chamber interior is not maintained at a hyperbaric pressure. The support structure includes structures complementary to the fasteners (e.g., apertures to pass bolts and locking knobs to secure bolts).

U.S. Pat. No. 7,975,331 B2 to Flocard et al describes the present disclosure concerns a device for controlling humidity at the surface of a supporting item (3) of the mattress or cushion type and in the vicinity of the body (13) of an individual resting thereon, comprising an envelope (1) formed by at least two parts (1.sub.1, 1.sub.2) connected with each other at their peripheral edges (1a, 1b), such as being sealed by welding (1c), defining an inner chamber (1.sub.3), the two parts having a first part (1.sub.1) intended to be positioned on the side of said body of the individual, and a second part (1.sub.2) intended to be positioned on the side of said supporting item (3) of the mattress or cushion type, the first part including a material forming a barrier impervious to air and liquid water and pervious to water vapor, the second part including a material pervious to water vapor, the second part comprising at least one air injection port (4) and means for discharging air comprising perforated or porous areas pervious to air, such as perforations (5).

U.S. Pat. No. 7,908,687 B2 to Ward et al describes a heating and cooling device for temperature conditioning an air supply for an air conditioned appliance, said heating/cooling device comprising: a first air passage for channeling a first air flow; a second air passage for channeling a second air flow; an inlet fan for drawing air into said first, air passage; an exhaust fan for drawing air through said second air passage; one or a plurality of heat exchangers for exchanging heat between air in said first air passage and air in said second exhaust air passage; wherein said first air passage comprises a tubular channel having an inlet at a first end and only one outlet, said outlet being at a second end of said passage, and said inlet fan is positioned at said inlet, such that said first air flow is channeled through said inlet fan, along the whole of said air passage, encountering all of said one or plurality of heat exchangers, and out of said outlet.

U.S. Pat. No. 7,877,827 B2 to Marquette et al describes a climate controlled seat, bed or other assembly configured to receive a person includes a blower and two or more thermoelectric devices or other conditioning fluid modules. According to one embodiment of an operational scheme, a control system for the seat or bed is configured to continuously discharge air from the blower through the thermoelectric devices. In one arrangement, the thermoelectric devices are sequenced between an activated and a deactivated position. Consequently, the desired cooling and/or cooling effect can be maintained while reducing energy consumption of the climate control system.

U.S. Pat. No. 7,389,554 B1 to Rose describes a high-profile air sleep system having a pair of air posturizing sleep surfaces which may be individually inclined and air adjusted comprises an air posturing module having an outer module mattress case. A first case section extends medially along a length of said mattress case to define a first movable posturing section, and a second case section extends along a length of said mattress case to define a second movable posturing section. A third fixed module case section is included in said mattress case below the first and second posturing sections. A first air chamber is carried in the first and third case sections, and a second air chamber is carried in the second and third module sections to provide first and second posturizing module sections with individually elevatable posturizing sleep surfaces.

U.S. Pat. No. 7,047,991 B2 to Kline describes a bed enclosure comprising a frame, a tent supported by the frame, and a mattress cover is disclosed. The frame employs a pair of opposed upright end members, an upper support bar connecting the upright end members, and an attachment bar connected to at least one of the upright end members which is movable up and down along a portion of the end member. The frame further includes a releasable fastener for fastening the attachment bar to the bed.

U.S. Pat. No. 6,952,844 B2 to Danaher describes a bed-tent that provides an enclosure over a mattress. The tent forms a canopy having spaced apart panels and a flexible cover extending between the panels. Each panel includes a hoop of flexible, resilient, strip material and a sheet of flexible fabric in the space within the hoop. Retainers secure the canopy on the mattress. A supporting frame holds the panels erect. The frame has stanchions disposed externally of the canopy and releasably connected to the panels. A frame member externally of the canopy above the cover holds the stanchions upright. The hoops can be twisted or wound into flat coils of reduced diameter so that the entire canopy can be conveniently stored in a small package. The legs and the frame member are made of segments that are normally held together by elastic cords. The segments can be pulled apart and separated for storage in a convenient package.

U.S. Pat. No. 6,748,760 B1 to Cheng describes an air conditioning apparatus that is provided to a hyperbaric oxygen chamber; the air conditioning apparatus being disposed inside the hyperbaric oxygen chamber, and comprising an air-actuated revolving member for making an axial flow fan thereof revolve so as to force air inside the chamber to travel through a cooling device thereof; thus, the temperature of air inside the chamber is maintained at a comfortably low level, and air circulation is enhanced for the users of the chamber.

U.S. Pat. No. 6,241,653 B1 to Gauger et al describes an isolation apparatus for the transport of a patient who is potentially infectious, who has been subjected to chemical or biological agents or who is threatened by chemical/biological attack. The invention comprises a transparent or semi-transparent, generally tubular enclosure, having two opposite ends. Secured to each of the two opposite ends of this transparent or semi-transparent, tubular enclosure are a pair of end walls. At least one semi-rigid support band extends around a portion of the outer periphery of the generally tubular enclosure. A base mat assembly, comprising at least a first flexible, flat sheet having a top side and a bottom side, is also a part of the invention. The top side of this first flat sheet is secured to the generally tubular enclosure. The bottom side of this sheet is secured to at least one reinforcing strap. Each of these one or more reinforcing straps has lateral ends, and the lateral ends of these straps are formed into loops. The loops serve as handholds, through which persons may grasp the isolation apparatus and transport the victim to another site for medical care. The base mat assembly of the isolation apparatus may also include a second flexible, flat sheet secured to the first flexible, flat sheet. In addition, at least two air inlet and outlet ports may be secured to each of the two end walls of the transparent or semitransparent, generally tubular enclosure.

U.S. Pat. No. 5,964,222 to Kotliar describes a hypoxic tent system which represents a portable travel version of Hypoxic Room System and is designated mostly for passive hypoxic training of athletes during rest. The system consists of a light portable tent, which can be easily erected on a bed or mattress. The tent is supported by a supporting structure, which can be disassembled in segments or deflated. Oxygen-depleted air is transmitted inside the tent by hypoxic generator, which employs membrane separation or pressure-swing adsorption principles for extracting oxygen from ambient air. Oxygen-depleted air is also filtered by HEPA filter and may be chilled by an optional air cooler. Hypoxic tent system can be easily packed in a travel case and installed in any hotel room by attaching to a bed. Hypoxic tent system provides a low-oxygen environment with preferably 11 to 15% oxygen and can also be used by disabled for exercising their cardiopulmonary systems, increasing strength, endurance and boosting immunity.

U.S. Pat. No. 5,725,565 to Smith describes a tanning bed control system including a tanning bed safety device (10) for ensuring safe operation of a tanning bed (14) is disclosed. The tanning bed safety device (10) monitors the operation of the tanning bed (14) and the tanning bed controller (12) and activates an alarm if the tanning bed (14) is on when it should be off or off when it should be on.

U.S. Pat. No. 5,384,925 to Vail describes an improved bed enclosure that is provided with a unique supporting structure which increases the vertical stability of the bed enclosure. The bed enclosure includes a frame having at least four upright side posts, each including an upper portion and a lower portion. The frame further includes upper frame support members interconnecting the upper portions of the side posts together, and lower frame support members interconnecting the lower portions of the side posts together. The frame defines a pair of generally vertical side walls of a predetermined length and a pair of opposed end walls of a predetermined width, the predetermined length being greater than the predetermined width. In accordance with one embodiment of the present invention, at least one support leg is associated with each of the side walls and is secured to the lower portions of the side posts and is engageable with the floor at a point spaced outwardly from the respective side wall. In accordance with another embodiment of the present invention, at least one support leg is associated with each of the side walls and is secured to the lower frame support members and is engageable with the floor at a point spaced outwardly from the respective side wall.

U.S. Pat. No. 4,432,354 to Lasley describes a portable chamber for enclosing a portion of the body for treatment with oxygen or other gas at pressures slightly above atmospheric and the control circuits for operating the chamber are disclosed. In its basic configuration, the chamber of the invention is designed to enclose a portion of the body, such as a leg or arm, but can be enlarged to enclose the entire body, except the head of the patient. In its basic design, the chamber of this invention is constructed in two parts that mate to form the chamber. When mated, one end of the chamber is closed and the other end is open to receive the part of the body being treated. The open end contains a sleeve that encircles the body part being treated to form an air tight seal. A gasket arrangement is provided to seal the two parts when mated. The control circuits or elements are fluidic elements. These fluidic elements are housed in a control box and coupled to the chamber by means of appropriate couplers mounted on the closed end of the chamber. A humidifier is also attached to the closed end of the chamber on the outside of the chamber.

U.S. Pat. No. D703,340 S to Soltesz-Nagy describes a horizontal tanning bed.

United States Patent No. 2013/0269106 A1 to Brykalski et al describes that according to some embodiments, a climate controlled bed or other seating assembly comprises an upper portion or mattress having at least one fluid distribution member (e.g., spacer fabric) that is in fluid communication with the at least one internal passageway of the upper portion, wherein the at least one fluid distribution member is configured to at least partially distribute fluid within the fluid distribution member. In some embodiments, the internal passageway terminates at or near a bottom surface of the upper portion or mattress. The bed or other seating assembly additionally includes one or more inlays or interlays or intermediate layers, or components thereof, positioned between the upper portion and a foundation.

United States Patent No. 2012/0131748 A1 to Brykalski et al describes a climate controlled bed that comprises a cushion member having an outer surface comprising a first side for supporting an occupant and a second side, the first side and the second side generally facing in opposite directions. hi some embodiments, the cushion member includes one or more recessed areas along its first side or its second side. In one embodiment, the bed further includes a flow conditioning member that may be at least partially positioned with the recessed area of the cushion member, an air-permeable topper member positioned along the first side of the cushion member and a fluid temperature regulation system.

United States Patent No. 2012/0000207 A1 to Parish et al describes a condensate management system that is adapted for use in a personal comfort system with an air conditioning system having a thermoelectric engine including a thermoelectric core, a supply heat exchanger and an exhaust heat exchanger. Condensate is managed by a primary condensate management system configured to draw condensate away from the thermoelectric core, the supply heat exchanger and/or the exhaust heat exchanger using wicking material. Optionally, a secondary condensation management system may be included which is configured to generate a condensate air flow operable for drawing moisture away from a collection tray.

United States Patent No. 2011/0306844 A1 to Young describes a pressure sensing devices for use with an inflatable bladder and monitoring apparatus for an at rest subject are disclosed herein. The device can comprise a housing comprising a recess and configured to be welded in a seam of the inflatable bladder. A pressure sensor can be located within the recess with a sensing side configured to be exposed to the cavity of the inflatable bladder and a reference side configured to be exposed to ambient air. A printed circuit board can be located within the recess and coupled to the pressure sensor. The pressure sensor is operable to detect a pressure change within the cavity due to a force exerted by a subject on the inflatable bladder.

United States Patent No. 2011/0289684 A1 to Parish et al describes a distribution system that is adapted for use with a mattress and a personal comfort system with an air conditioning system operable for outputting a conditioned air flow. The distribution system includes at least top and bottom layers of fabric material and a spacer structure disposed between the bottom and top layers. The spacer structure defines an internal volume within the distribution layer and is configured to enable the received conditioned air flow to flow therethrough. This flow of conditioned air has a cooling or heating effect on a body on the mattress.

United States Patent No. 2011/0258778 A1 to Brykalski et al describes that according to certain arrangements, a conditioner mat for use with a bed assembly includes an upper layer comprising a plurality of openings, a lower layer being substantially fluid impermeable, at least one interior chamber defined by the upper layer and the lower layer and a spacer material positioned within the interior chamber. In one embodiment, the spacer material is configured to maintain a shape of the interior chamber and to help with the passage of fluids within a portion of interior chamber. The conditioner mat additionally includes an inlet in fluid communication with the interior chamber, at least one fluid module comprising a fluid transfer device and a conduit placing an outlet of the at least one fluid module in fluid communication with the inlet. In some arrangements, the fluid module selectively delivers fluids to the interior chamber through the conduit and the inlet. In one embodiment, fluids entering the chamber through the inlet are generally distributed within the chamber by the spacer material before exiting through the plurality of openings along the upper layer. The conditioner mat can be configured to releasably secure to a top of a bed assembly.

United States Patent No. 2011/0115635 A1 to Petrovski et al describes a climate-conditioned bed that includes an upper portion having at least a first climate zone and at least one fluid module associated with such a first climate zone. The fluid module comprises a fluid transfer device for selectively moving a fluid and a thermoelectric device for selectively heating or cooling a fluid. The bed additionally includes one or more control modules configured to regulate the operation of the fluid module, at least one input device configured to allow an occupant to select a setting or mode associated with the first climate zone and at least a first temperature sensor configured to detect a temperature associated with the first climate zone of the thermally-conditioned bed. In some embodiments, the fluid module is operatively connected to the control module. The control module is configured to adjust at least one operational parameter of the fluid module based on, at least in part, the setting or mode selected by an occupant using the at least one input device, and the temperature detected by the first temperature sensor.

United States Patent No. 2007/0033733 A1 to Jen describes a mattress air-conditioning system is disclosed to include a mattress, a main breathing tube embedded in the mattress, a plurality of branch breathing tubes symmetrically perpendicularly extending from the main breathing tube at two sides and embedded in the mattress, and a hot/cold air blower disposed outside the mattress and connected to one end of the main breathing tube and controllable to provide hot/cold air to the main breathing tubes and the branch breathing tubes to regulate the temperature of the mattress.

United States Patent No. 2005/0278863 A1 to Bahash et al describes an improved comfort product that uses an airflow through a heat exchanger and into the comfort product to selectively heat or cool an occupant has a support layer contacting and supporting a channel layer. The channel layer has at least one channel with an opening to accept air. The channel layer contacts and supports an engineered distribution layer that has numerous small holes making it air permeable. The engineered distribution layer contacts and supports an air permeable comfort layer that is of such size and shape to support an occupant of the comfort product. The comfort product also has a heat exchanger assembly for supplying heated or cooled air to the opening in the channel. The heat exchanger assembly includes an air intake having an intake fan, an exhaust outlet and a heat exchanger for selectively heating or cooling air flowing through the heat exchanger resulting in selectively heated or cooled supply air and exhaust air. The intake fan forces air through the heat exchanger where some of the air is selectively heated or cooled to be supplied to the comfort product and some air is used as exhaust air (to remove the unwanted heat if the supplied air is cooled or to warm the exhaust side of the heat exchanger if the supply air is warmed.). The selectively heated or cooled supply air then moves through the channels in the channel layer and the exhaust air exits through the exhaust vent. The selectively heated or cooled supply air then moves through the engineered distribution layer where the numerous small holes diffuse the air and then the selectively heated or cooled air then moves through the comfort layer where the air is further diffused and where the selectively heated or cooled air can selectively heat or cool an occupant of the comfort product.

United States Patent No. 2005/0235418 A1 to Jacques, II et al describes a bed enclosure for a health care facility bed including a frame and a mattress to support a patient. The enclosure includes a shell and a frame to support the shell.

Notwithstanding the prior art, the present invention is neither taught nor rendered obvious thereby.

### SUMMARY OF INVENTION

The present invention is directed to an environmentally controlled sleep pod, which includes: a) a main frame having an elevated base for supporting a mattress and having a mechanical system storage area under the base, and having walls extending upwardly from the base, the walls including a mattress sidewall portion and an above-mattress rail portion; b) a mattress located on the elevated base; c) a mechanical system located in the mechanical system storage area, the mechanical system including heating and air-conditioning and a power source connector; d) at least one feed conduit connected to the mechanical system and extending up the main frame walls to the above-mattress rail portion for feeding air from the mechanical system to above the mattress; e) at least one return conduit connected to the above-mattress rail portion of the main frame walls and extending down the main frame walls and connected to the mechanical systems for returning air from above the mattress to the mechanical system; f) a control device for controlling heating and cooling of air at the mechanical system; and, g) a moveable hood connected to the main frame and having a first, open position and a second, closed position.

In some embodiments of the present invention environmentally controlled sleep pod, the control device is selected from the group consisting of a wireless control device and a wired control device.

In some embodiments of the present invention environmentally controlled sleep pod, the control device is selected from the group consisting of cell phone, PDA, computer, tablet and dedicated device.

In some embodiments of the present invention environmentally controlled sleep pod, the control device includes temperature setting means and an on-off switch.

In some embodiments of the present invention environmentally controlled sleep pod, the mechanical system includes at least one moisture controlling component selected from the group consisting of a humidifier and dehumidifier.

In some embodiments of the present invention environmentally controlled sleep pod, the hood is a hinged hood with a handle selected from the group consisting of a manual hood, and electrically driven hood, a hydraulic and a counterweighted hood.

In some embodiments of the present invention environmentally controlled sleep pod, the hood is at least partially transparent.

In some embodiments of the present invention environmentally controlled sleep pod, at least a portion of the hood is a photosensitive transformative panel that is transparent in sunlight and opaque in the absence of significant sunlight.

In some embodiments of the present invention environmentally controlled sleep pod, the main frame and mattress have sufficient width to accommodate two people and the hood is a gull wing hood.

In some embodiments of the present invention environmentally controlled sleep pod, the mattress includes a massaging mechanism.

In yet other embodiments of the present invention environmentally controlled sleep pod, includes: a) a main frame having an elevated base for supporting a mattress and having a mechanical system storage area under the base, and having walls extending upwardly from the base, the walls including a mattress sidewall portion and an above-mattress rail portion; b) a mattress located on the elevated base; c) a mechanical system located in the mechanical system storage area, the mechanical system including heating and air-conditioning and a power source connector; d) at least one feed conduit connected to the mechanical system and extending up the main frame walls to the above-mattress rail portion for feeding air from the mechanical system to above the mattress; e) at least one return conduit connected to the above-mattress rail portion of the main frame walls and extending down the main frame walls and connected to the mechanical systems for returning air from above the mattress to the mechanical system; f) a control device from controlling heating and cooling of air at the mechanical system; g) a moveable hood connected to the main frame and having a first, open position and a second, closed position; and h) a sound system contained within the sleep pod to provide at least one of music and soothing sleep sounds. In these embodiments, all of the features set forth in the previous paragraphs may be included or added here, individually, collectively or in any combination, without exceeding the scope of the present invention.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE SEVERAL VIEWS OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows a block diagram illustrating some of the critical features of the present invention sleep pod with controlled environment;

FIG. 2 shows a block diagram illustrating some of the options and details of the present invention sleep pod with controlled environment;

FIG. 3 represents a diagrammatic presentation of the mechanical aspects of the present invention sleep pod with controlled environment showing one possible flow path arrangement;

FIG. 4 shows a side cut view of one embodiment of a present invention sleep pod with controlled environment;

FIG. 5 illustrates and end view of a double bed of a present invention sleep pod with the footboard partially removed, with controlled environment with gull winged lids to accommodate two people;

FIG. 6 shows an end view of another embodiment of present invention sleep pod with controlled environment; and,

FIG. 7 illustrates a block diagram of preferred features of another embodiment of the present invention sleep pod with controlled environment.

### DETAILED DESCRIPTION OF THE EMBODIMENTS

The following discussion features examples of the present invention as well as preferred embodiments thereof, and the present invention should not be construed to be limited to these examples.

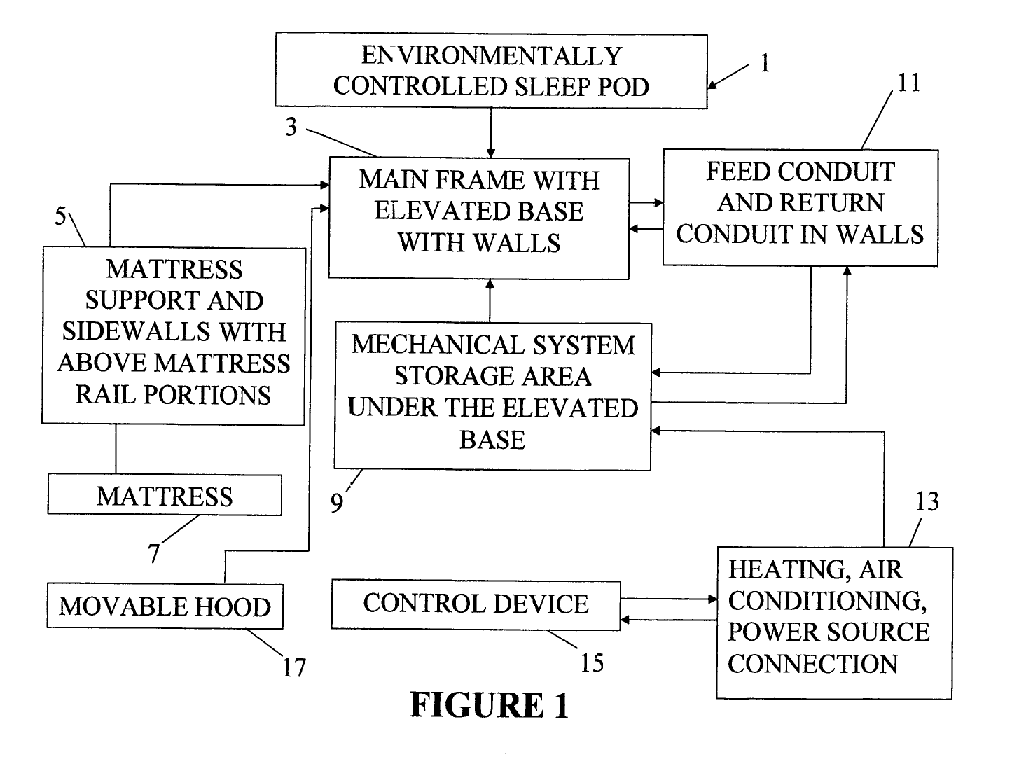

FIG. 1 shows a block diagram 1 illustrating some of the critical features of the present invention environmentally controlled sleep pod. There is a main frame with an elevated base with walls, block 3. The walls are side walls that rise above the level of a mattress, block 7. These side walls have an above-mattress rail portion and may be positioned adjacent the mattress and above it, block 5. These above mattress rail portions are necessary to permit air flow above and across a mattress to maximize delivery of heat, air conditioning and humidity controls to a user. Thus, the main frame elevated base includes the mattress support, block 5. The main frame has a mechanical system storage area under the elevated base, block 9, and this mechanical system storage area includes, minimally, heating and air conditioning and a power source connection, block 13. The power source connection may be a wired connection to a situ power source, such as a fuel cell or battery, or it may be hard wired to an external power source or it may be a wire and plug for 110 or 220 volt or other common electrical service.

As shown in FIG. 1, block 11, conduits feed and return environmentally controlled air from and to the mechanical storage area heating and air conditioning units via the main frame walls. A control device, block 15, is used to turn the heating and air conditioning on and off and/or to set a specific temperature. The control device, block 15, may be a dedicated remote control or the control device may be installed in a computer, PDA, tablet, cell phone or other wireless device. It may be wired or wireless.

Block 17 of FIG. 1 shows a movable hood and this is attached to the main frame. This hood may be one that slides vertically or at an angle or rotates or folds or recesses. It may be hand operated or motor driven. If motor driven, it may be controlled with a wired or wireless controller that may or may not be integrated into a control device, block 15.

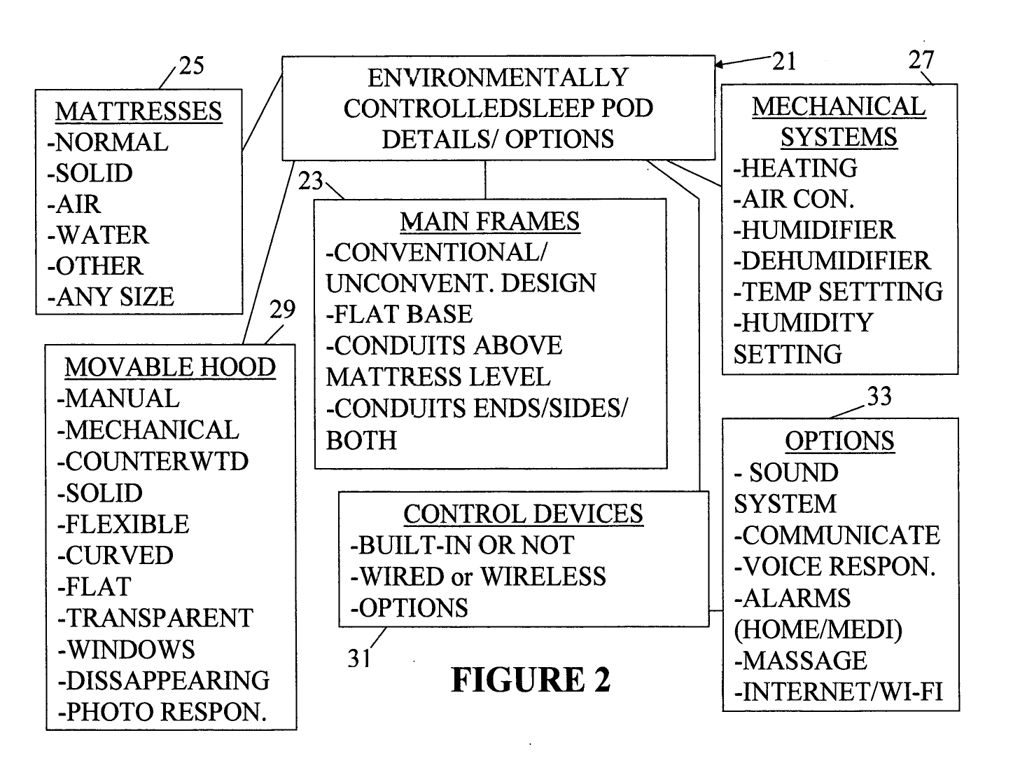

FIG. 2 shows a block diagram 2 illustrating some of the options and details of the present invention sleep pod with controlled environment. Block 23 illustrates some preferred main frame features. The frames may have the design or appearance of conventional bed frames with headboards and footboards or they may be unconventional. Given that they have movable hoods, a simple design could involve symmetrical headboard and footboard (same height and shape). Alternatively, a higher headboard and a lower footboard would inherently allow for a downwardly tapered hood and, if transparent, would permit a user to see forwardly beyond the pod, as well as upwardly and sideways. The base of the main frame is generally flat, but could be otherwise concave, convex, rippled, slatted or any desired configuration to support a mattress or to act as a mattress (in some societies, sleeping on boards is acceptable). The conduits have vents that must be above the mattress level to permit free flowing air currents above the mattress. These conduits and vents may be manifolded to have multiple vents on the side walls. The mattresses, block 25, may be made of any material, such as any normal mattress, or a solid mattress such as wood or metal or plastic. Alternatively, these mattresses may be air mattresses, water beds, hybrids or any other known mattress format. The size of the main frame and the mattress may range from very small (infant) to very large (king). Given the functionalities available with the present invention sleep pod, the size may range from smaller than a crib to larger than a king size and, in some embodiments, may have heights designed to permit sitting up in bed, even with the hood closed.

Block 27 shows some mechanical system features. Basic are heating and air conditioning, but humidification and dehumidification are preferred. Besides providing individual or couple custom comfort sleeping, the present invention enables users to lower their heat or air conditioning requirements throughout their entire homes by having a comfortable controlled environment within the pod. For example, normally a person might reduce heat from 70° F. to 67° F. while sleeping. With the present invention, room settings may be reduced to 50° F. or lower while maintaining the pod at a comfortable sleep temperature such as 68° F. Thus, the present invention is truly a green product that will significantly reduce fuel consumption for both heating and air conditioning. These mechanical systems may have temperature and/or humidity setting capabilities, much like a home thermostat or humidistat.

Block 29 illustrates that the movable hoods may be manual or mechanical (motor driven). In either case, the movable hoods, block 29, may be counterweighted to reduce apparent weight for ease of opening and closing. These hoods may be solid or flexible or combinations, such as solid with a portion as a flexible drape. However, preferred hoods are structurally solid although they may be transparent, translucent, opaque or combinations thereof. They may have curved shapes or flat shapes with or without windows and may be disappearing (such as drop downs into walls or even disappearing accordion sectioned hoods). In some preferred luxury versions, the present invention hoods may be partially or fully photo-responsive (like photo grays darkening in the sun light and clarifying at night) these would be chemically modified transparency, reacting to photons (light).

Block 31 illustrates that the control devices may be built-in or may be not built-in, such as hand held control devices, they could be wired or wireless and, as mentioned could be incorporated into any computing device. The control devices of block 31 will control the mechanical systems and may control much more, such as options of block 33. These options include music systems. Music systems include any electronic source of music as well as received or installed sleep soothing sounds. They may include private collections on any form of chip, satellite radio, regular radio and the option of playing CDs, MP3s or other sound media, communications systems, such as speaking with other pods or resident broadcasting or cell phone capabilities or combinations of these cell phone capabilities. Alarms may include wireless connection to a home invasion alarm system, or a medical alarm system, or a medical monitoring alarm system that may include sensors for vital functions, or communications with alarms in other pods. These present invention pods may also include interne connections, built-in fixed or movable screens and may have Wi-Fi, Bluetooth or other connectivity. In some preferred luxury models, built-in massage systems will be included and will be located on the mattress support for under mattress motion that is transferred to the user. In some case, oxygen supplies are included to enhance the breathing and well being of the user.

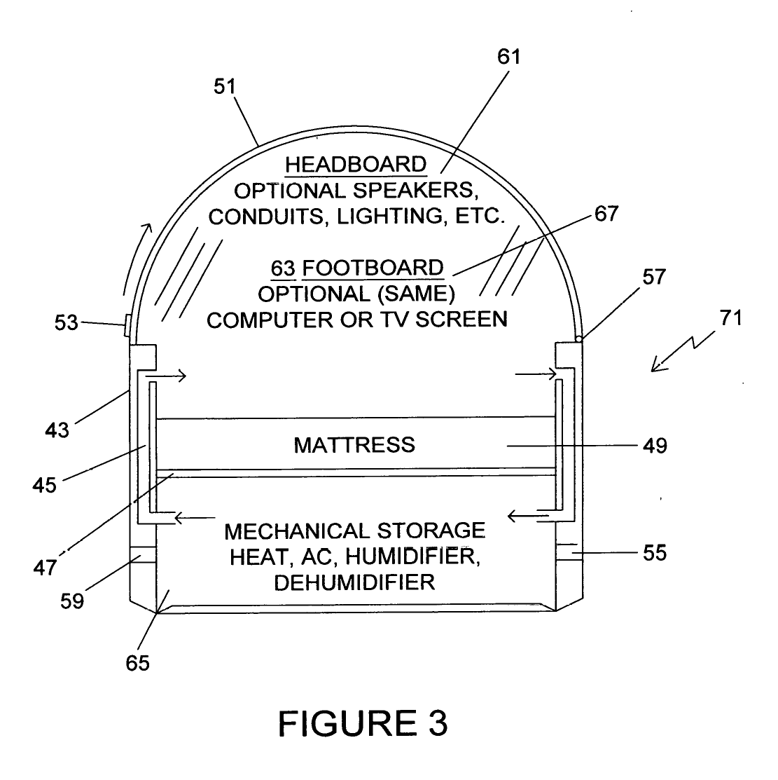

FIG. 3 represents a diagrammatic presentation of the mechanical aspects of the present invention sleep pod 41 with controlled environment, showing one possible flow path arrangement for controlled airflow. Sleep pod 41 of FIG. 3 is a cut end view of the footboard removed. It includes sidewalls such as sidewall 43 with a mattress support base 47 and mattress 49. Under mattress support base 47 is a mechanical storage area or vault 65 for holding mechanical systems, such as heating, air conditioning, humidifier and dehumidifier. Vault 65 has conduits (small ductwork, tubes or passageways) to permit flow of air to and from the mechanical systems for treatment. For good circulation across a user, there are inlets and outlets at the mechanical devices, as well as areas above mattress 49. For example, conduit 45 shows an inlet arrow inside vault 65 and an outlet arrow in the sleep area 63 above mattress 49. Headboard 61 may have any front footprint shape but is illustrated here as a simple arcuate shape. Hood 51 has handle 53 and hinges 57 and may be counterweighted for case of opening and closing. It may close to “seal” the user, with or without openings, windows or ventilation orifices. However, external intake and exhaust may be included such as external ports 55 and 59 at vault 65. Headboard 61 will include various comfort features such as speakers, additional air conduits with vents, lighting, computer screens and control panels. The footboard 67 may have any of these options, as well as a computer and/or TV screen. In some embodiments this screen may be retracted and hidden in the footboard and exposed or otherwise opened at the touch of a button or with a wireless remote controller.

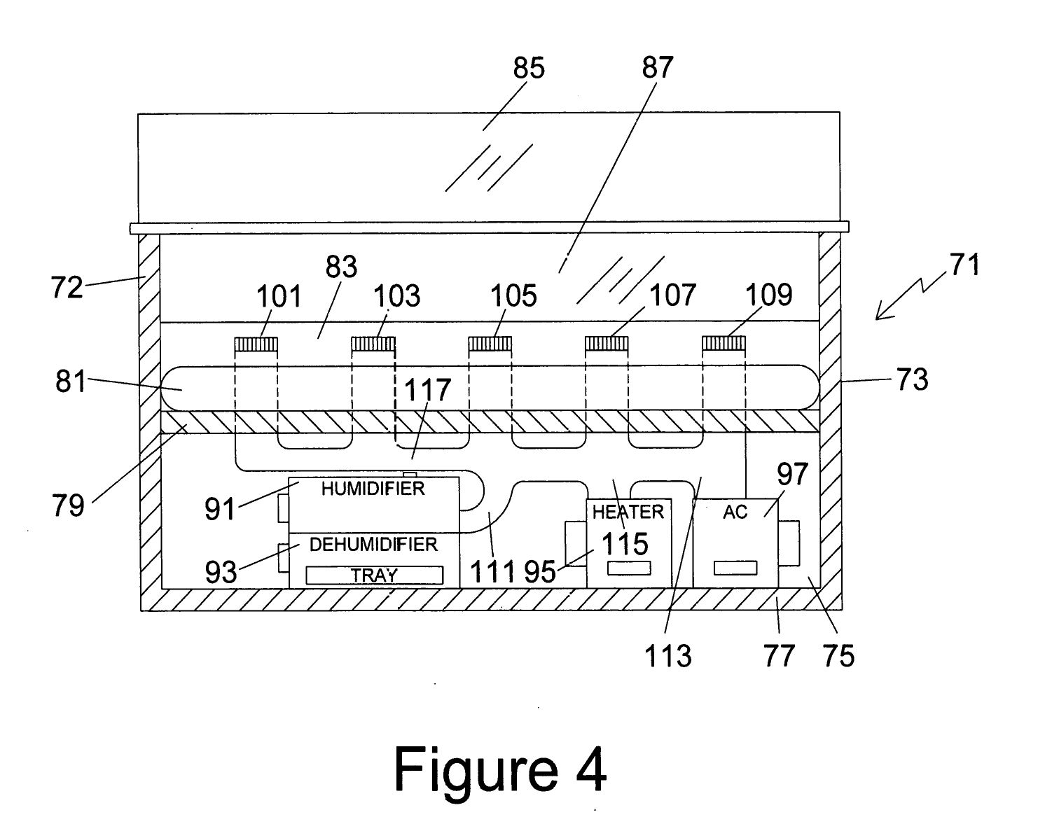

FIG. 4 shows a side cut view of one embodiment of a present invention sleep pod with controlled environment. Sleep pod 71 has a headboard 72 and a footboard 73, as well as a bottom 77 and a mattress support base 79. Between bottom 77 and mattress support base 79 is mechanical storage area 75 with humidifier 91, dehumidifier 93, heater 95, air conditioner 97 and a manifolded vent system with conduits 111, 113, 115 feeding manifold 117. Manifold 117 distributes treated air flow evenly above mattress 81 with controlled environment vents 101, 103, 105, 107, and 109 in sidewall 83. These vents may be individually manually controlled, mechanically controlled and interconnected, wirelessly controlled by a user or independently controlled by feedback sensors that respond to user settings. Present invention sleep pod 71 has a two section hood (right lid 85, open and left lid 87, closed).

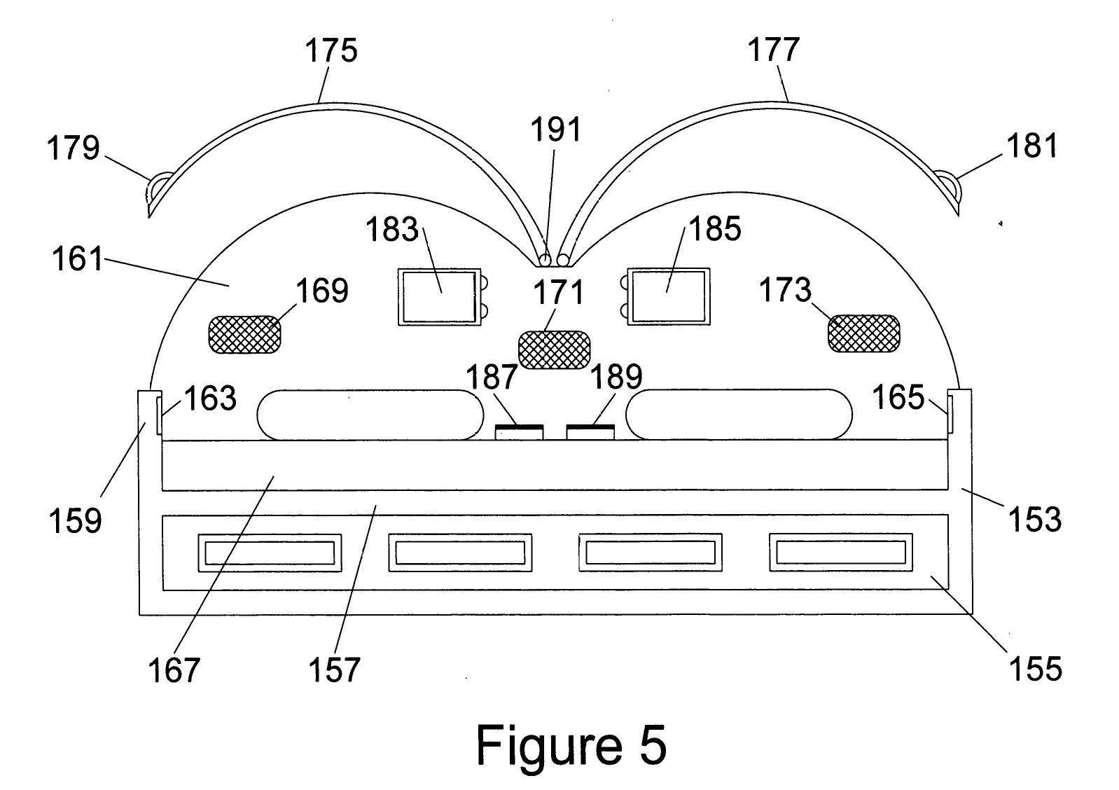

FIG. 5 illustrates and end view of a double bed of a present invention sleep pod 151 with the footboard partially removed, with controlled environment and with gull winged hoods to accommodate two people. Thus, FIG. 5 shows present invention environmentally controlled sleep pod 151 with a mainframe 153 and a mechanical system storage area 155. Above storage area 155 is elevated base 157 and mattress 167. Air feed conduit 163 and air return conduit 165 are located in the frame walls such as frame wall 159. Not shown, but contained within mechanical system storage area 155 are heating, air conditioning, humidifier, and dehumidifier units. In this embodiment, sleep pod 151 is a double bed with a dual arcuate headboard 161. Sleep pod 151 has the footboard removed but it could be the same size as headboard 161 and could be solid or could have a transparent upper half. As with all of the present invention sleep pods, sleep pod 151 includes a moveable hood to permit user(s) to enter easily. In this example, the hood has two components that form “gull wings” and have left wing 175 and right wing 177 with lift handles 179 and 181. There are common hinge connections 191 and these wings may be solid (opaque), translucent, transparent or combinations thereof. In this embodiment the wings 175 and 177 may have a constant cross section and, when closed, nest upon the headboard, footboard and the side wall rails.

In another version of sleep pod 151 shown in FIG. 5, the footboard (not shown) could be lower than the headboard and the wings 175 and 177 could be tapered forward like a fighter jet cockpit acrylic canopy.

Headboard 161 includes swing out screens 183 and 185 for two users. These may be wired or wireless and may be used with computers, internet, television, movie, games, gaming, security monitoring, remove alarm signaling or other monitor display use. There are his and her remote units 187 and 189. These may be controllers for the environment, meaning temperature and humidity settings, as well as controllers for functions such as those described above with respect to the screens 183 and 185. In addition, left, right and center speakers 169, 171, and 173 act as output speakers for music, radio, television, music storage devices, computers, cell phone functions and any other speaker functions. Additionally, one or more of these may be receivers for any voice activated functions, such as controlling the environment of the pod, operating computers/screens, controlling external electronics such as household heating, air conditioning, humidity, lighting, security system activation, etc.

As now can be seen, the present invention sleep pod contemplates a controlled, peaceful sleep environment with numerous amenities and the ability for user(s) to control not only the sleep pod, but the surrounding home environment. User(s) will be able to use a cell phone feature, order a wakeup call, download a movie, play games with remote opponents, use sleep mode sounds, activate optional massage devices and even include Sleep Number beds and motorized tilt beds. By heating or cooling the sleep pod, the remainder of an entire house can have its heat or air conditioning requirements minimalized with concomitant fuel/energy cost reductions, with positive ramifications for the environment.

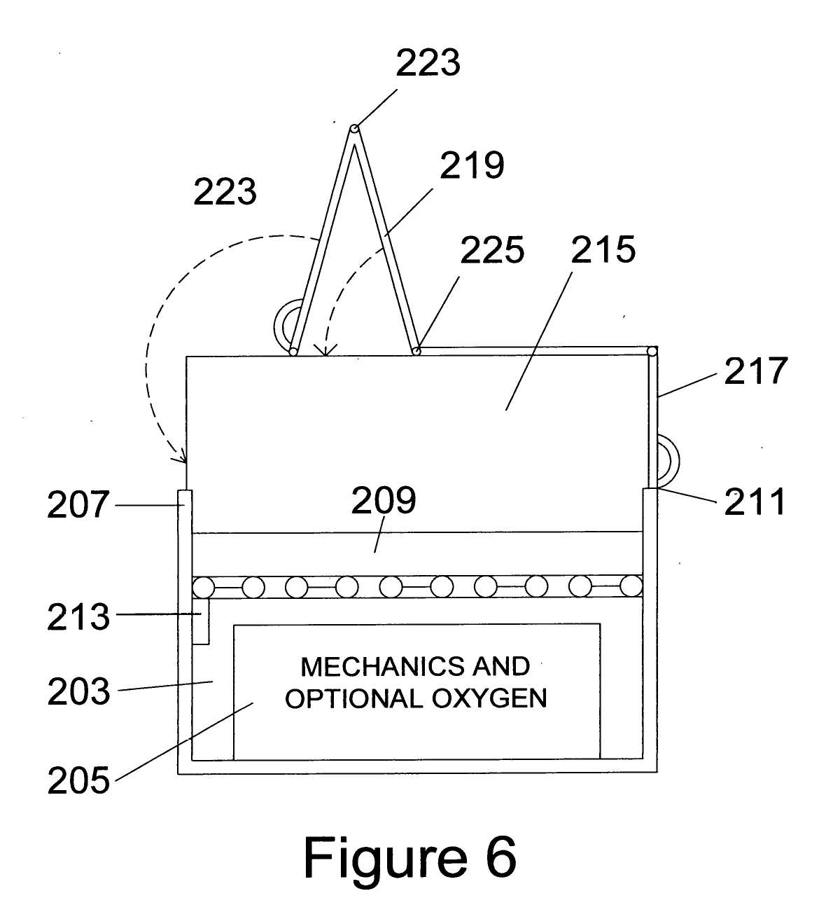

FIG. 6 shows an end view of another embodiment of present invention sleep pod 201 with controlled environment. Sleep pod 201 is a single user unit with many features described above (not shown). It includes mainframe 203, a mechanical system storage area 205, an elevated mattress base 213 and a mattress 209. It has side rails such as side rail 207 with a headboard 215. A folding hood includes right section 217, which is closed, and an open section comprised of side 221, hinge 223, top 219 and hinge 225. Between mattress 209 and elevated base 213 is a massage mechanism 211. This is activated by the user for in-pod massage treatments that may include control over massage speeds, formats and locations. In addition, mechanical system storage area 205 may contain one or more oxygen tanks that will controllably feed into the pod for healthy breathing, healing and other recognized health benefits.

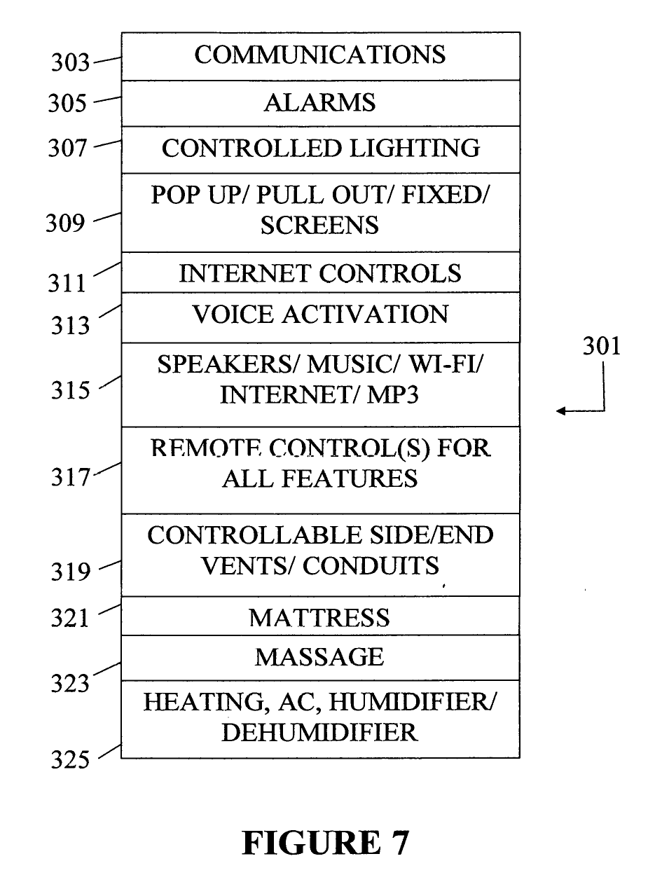

FIG. 7 illustrates a block diagram 301 of preferred features of another embodiment of the present invention sleep pod with controlled environment. It includes block 303 communications, block 305 alarms, block 307 controlled lighting, block 309 pop up/pull out/fixed screens, and block 311 internet controls. It further includes block 313 voice activation, block 315 spealcers/music/wifi/internet/mp3, block 317 remote control(s) for all features, and block 319 controllable side/end vents/conduits. It also includes block 321 mattress, block 323 massage, block 325 heating, air conditioning, humidifier/dehumidifier. Additional features not included in this diagram are set forth above.

It can now be seen that the present invention sleep pod is a self contained, controlled unit that is an enclosed sleep chamber with all of the features described above. The components/materials of construction will preferably include thermal insulation and sound insulation to optimize the use and efficiency of the sleep pod. In some embodiments, the unit may be wheeled to enhance mobility; it may be modular so as to physically or wirelessly connect with other sleep pods; control units may have personalized settings. In some designs, the headboards and footboards or other upper portion members may be constructed to receive additional units in a stacked format, like bunk beds. Many of the features may be retractable such as the screens described above and could be hidden. Alarm features may be sophisticated and relate to sleep phase monitoring. In some luxury models, self-sanitation cycles using, for example, ultraviolet devices, could be included. Likewise, some models could contain a power interruption back up power source. These could be fuel cells, batteries or other means.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims. For example, the actual shape of the main housing may be any of numerous possibilities as long as its functionality as described is not affected adversely.

What is claimed is:

1. An environmentally controlled sleep pod, which comprises:
a) a main frame having an elevated base for supporting a mattress and having a mechanical system storage area under said base, and having walls extending upwardly from said base, said walls including a mattress sidewall portion and an above-mattress rail portion;
b) a mattress located on said elevated base;
c) a mechanical system located in said mechanical system storage area, said mechanical system including heating and air-conditioning and a power source connector;
d) at least one feed conduit connected to said mechanical system and extending up said main frame walls to said above-mattress rail portion for feeding air from said mechanical system to above said mattress;
e) at least one return conduit connected to said above-mattress rail portion of said main frame walls and extending down said main frame walls and connected to said mechanical systems for returning air from above said mattress to said mechanical system;
f) a control device for controlling heating and cooling of air at said mechanical system; and,
g) a moveable hood connected to said main frame and having a first, open position and a second, closed position.

2. The environmentally controlled sleep pod of claim 1 wherein said control device is selected from the group consisting of a wireless control device and a wired control device.

3. The environmentally controlled sleep pod of claim 2 wherein said control device is a wireless control device selected from the group consisting of cell phone, PDA, computer, tablet and dedicated device.

4. The environmentally controlled sleep pod of claim 2 wherein said control device includes temperature setting means and an on-off switch.

5. The environmentally controlled sleep pod of claim 1 wherein said mechanical system includes at least one moisture controlling component selected from the group consisting of a humidifier and dehumidifier.

6. The environmentally controlled sleep pod of claim 1 wherein said hood is a hinged hood with a handle selected from the group consisting of a manual hood, and electrically driven hood, a hydraulic and a counterweighted hood.

7. The environmentally controlled sleep pod of claim 1 wherein said hood is at least partially transparent.

8. The environmentally controlled sleep pod of claim 1 wherein at least a portion of said hood is a photosensitive transformative panel that is transparent in sunlight and opaque in the absence of significant sunlight.

9. The environmentally controlled sleep pod of claim 1 wherein said main frame and mattress have sufficient width to accommodate two people and said hood is a gull wing hood.

10. The environmentally controlled sleep pod of claim 1 wherein said mattress includes a massaging mechanism.

11. An environmentally controlled sleep pod, which comprises:
a) a main frame having an elevated base for supporting a mattress and having a mechanical system storage area under said base, and having walls extending upwardly from said base, said walls including a mattress sidewall portion and an above-mattress rail portion;
b) a mattress located on said elevated base;
c) a mechanical system located in said mechanical system storage area, said mechanical system including heating and air-conditioning and a power source connector;
d) at least one feed conduit connected to said mechanical system and extending up said main frame walls to said above-mattress rail portion for feeding air from said mechanical system to above said mattress;
e) at least one return conduit connected to said above-mattress rail portion of said main frame walls and extending down said main frame walls and extending down said main frame walls and connected to said mechanical systems for returning air from above said mattress to said mechanical system;
f) a control device from controlling heating and cooling of air at said mechanical system;
g) a moveable hood connected to said main frame and having a first, open position and a second, closed position; and,
h) a sound system contained within said sleep pod to provide at least one of music and soothing sleep sounds.

12. The environmentally controlled sleep pod of claim 11 wherein said control device is selected from the group consisting of a wireless control device and a wired control device.

13. The environmentally controlled sleep pod of claim 12 wherein said control device is a wireless control device selected from the group consisting of cell phone, PDA, computer, tablet and dedicated device.

14. The environmentally controlled sleep pod of claim 12 wherein said control device includes temperature setting means and an on-off switch.

15. The environmentally controlled sleep pod of claim 11 wherein said mechanical system includes at least one moisture controlling component selected from the group consisting of a humidifier and dehumidifier.

16. The environmentally controlled sleep pod of claim 11 wherein said hood is a hinged hood with a handle selected from the group consisting of a manual hood, and electrically driven hood, a hydraulic and a counterweighted hood.

17. The environmentally controlled sleep pod of claim 11 wherein said hood is at least partially transparent.

18. The environmentally controlled sleep pod of claim 11 wherein at least a portion of said hood is a photosensitive transformative panel that is transparent in sunlight and opaque in the absence of significant sunlight.

19. The environmentally controlled sleep pod of claim 11 wherein said main frame and mattress have sufficient width to accommodate two people and said hood is gull wing hood.

20. The environmentally controlled sleep pod of claim 11 wherein said mattress includes a massaging mechanism.
